(19) United States
(12) Patent Application Publication
(10) Pub. No.: US 2026/0349097 A1
(43) Pub. Date: Nov. 5, 2026

(54) Solid State TOF Lidar with Coaxial Illumination

(71) Applicant: Microvision, Inc., Redmond, WA (US)

(72) Inventor: Till Steinbach, Hamburg (DE)

(73) Assignee: Microvision, Inc., Redmond, WA (US)

(21) Appl. No.: 19/199,095

(22) Filed: May 5, 2025

(51) Int. Cl. G01S 7/497; G01S 7/481; G01S 7/484; G01S 7/4863; G01S 7/4865

(52) U.S. Cl. CPC G01S 7/497; G01S 7/4812; G01S 7/4815; G01S 7/4816; G01S 7/484; G01S 7/4863; G01S 7/4865; G01S 2007/4975

(57) ABSTRACT

Aspects of the subject disclosure may include, for example, a LIDAR measurement system that includes a transmitter module, a receiver module, a single lens system positioned along a coaxial optical path, and a beam splitter to direct laser light pulses and their reflections. The system performs operations such as emitting laser pulses, receiving reflections, and detecting obstructions in the lens system. Other embodiments are disclosed.

### FIELD OF THE DISCLOSURE

The subject disclosure relates to Light Detection And Ranging (LIDAR) measurement systems.

### BACKGROUND

LIDAR measurement systems are commonly used in automotive applications to measure distances between a vehicle and objects around the vehicle. LIDAR measurement systems are typically recessed in a vehicle body panel (e.g., front bumper cover) for aesthetic reasons.

### BRIEF DESCRIPTION OF THE DRAWINGS

Reference will now be made to the accompanying drawings, which are not necessarily drawn to scale, and wherein:

FIG. 1 shows a LIDAR measurement system in accordance with various aspects described herein;

FIG. 2 shows a transmitter module and a receiver module schematically in a front view in accordance with various aspects described herein;

FIGS. 3 and 4 show automotive applications of LIDAR measurement systems in accordance with various aspects described herein;

FIG. 5 shows a perspective view of a LIDAR measurement system in accordance with various aspects described herein;

FIG. 6 shows a cross section view of a LIDAR measurement system in accordance with various aspects described herein;

FIG. 7 shows a cross section view of a LIDAR measurement system in accordance with various aspects described herein;

FIG. 8 shows a timing diagram representing operation of a LIDAR measurement system in accordance with various aspects described herein;

FIG. 9 shows a timing diagram representing operation of a LIDAR measurement system in accordance with various aspects described herein;

FIG. 10 depicts an illustrative embodiment of a method in accordance with various aspects described herein.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. Like numerals in the drawings refer to the same or similar functionality throughout the several views.

One or more aspects of the subject disclosure include a system, comprising a transmitter module including a plurality of emitter elements configured to emit laser light pulses on a first optical path, a receiver module including a plurality of sensor elements configured to detect reflections of the laser light pulses on a second optical path, a single lens system positioned along a coaxial optical path, and a beam splitter configured to direct the laser light pulses from the first optical path to the coaxial optical path and to direct the reflections of the laser light pulses from the coaxial optical path to the second optical path. The system further includes a processing system comprising a processor and a memory that stores executable instructions. When executed by the processing system, the instructions facilitate performance of operations, which may include emitting a first set of laser light pulses from the plurality of emitter elements, receiving a first set of reflections of the first set of laser light pulses at less than all of the plurality of sensor elements, and determining that the first set of reflections were reflected by the single lens system.

Additional aspects of the subject disclosure may include a mirror positioned to reflect a portion of the laser light pulses onto the second optical path to enable the receiver module to test the transmitter module. The system may further include a test receiver module positioned to receive a portion of the laser light pulses to test the transmitter module. In some embodiments, the test receiver module may comprise a second plurality of sensor elements, wherein the number of the plurality of sensor elements of the receiver module is equal to the number of the second plurality of sensor elements of the test receiver module. Alternatively, the test receiver module may comprise a complementary metal oxide semiconductor (CMOS) detector.

In some embodiments, the operations may further include enabling the plurality of sensor elements during a time period that allows reflections to be received from the single lens system and that does not allow reflections to be received from objects in a field of view beyond the single lens system. Additionally, the single lens system may be positioned to protrude through a housing of the system to provide a field of view of at least 180 degrees in at least one dimension. Further, in some embodiments, the single lens system may be positioned to protrude through a housing of the system to provide a field of view of at least 180 degrees in two dimensions (e.g., vertical dimension and horizontal dimension).

Further aspects may include integrating, at each of the plurality of sensor elements, ambient light received through the single lens system over time, detecting a lower return on at least one of the plurality of sensor elements, and determining, based on the lower return, that the single lens system has an obstruction.

One or more aspects of the subject disclosure include a light detection and ranging (LIDAR) measurement system, comprising a transmitter module including a plurality of emitter elements configured to emit laser light pulses on a first optical path, a receiver module including a plurality of sensor elements configured to detect reflections of the laser light pulses on a second optical path, a single lens system positioned along a coaxial optical path, and a beam splitter configured to direct the laser light pulses from the first optical path to the coaxial optical path and to direct the reflections of the laser light pulses from the coaxial optical path to the second optical path. The system further includes a mirror positioned to reflect a portion of the laser light pulses emitted by the transmitter module back toward the receiver module, a processing system comprising a processor, and a memory that stores executable instructions. When executed by the processing system, the instructions facilitate performance of operations, which may include measuring degradation of the plurality of emitter elements over time based on the portion of the laser light pulses reflected by the mirror and detected by the receiver module.

Additional aspects of the subject disclosure may include modifying a power output of the plurality of emitter elements in response to the degradation of the emitter elements over time. In some embodiments, the modifying of the power output may comprise individually adjusting the power output of each emitter element in the plurality of emitter elements to optimize performance and maintain consistent operation.

Further aspects may include emitting a first set of laser light pulses from the plurality of emitter elements, receiving a first set of reflections of the first set of laser light pulses at less than all of the plurality of sensor elements, and determining that the first set of reflections were reflected by the single lens system.

In some embodiments, the single lens system may be positioned to protrude through a housing of the LIDAR measurement system to provide a field of view of at least 180 degrees in at least one dimension, enabling a wide coverage area for detection and measurement. Further, in some embodiments, the single lens system may be positioned to protrude through a housing of the system to provide a field of view of at least 180 degrees in two dimensions (e.g., vertical dimension and horizontal dimension).

Additional operations may include integrating, at each of the plurality of sensor elements, ambient light received through the single lens system over time, detecting a lower return on at least one of the plurality of sensor elements, and determining, based on the lower return, that the single lens system has an obstruction. This functionality may enhance the system's ability to identify and address issues such as contamination or blockage of the lens system.

One or more aspects of the subject disclosure include a method, comprising emitting laser light pulses on a first optical path by a transmitter module including a plurality of emitter elements, directing the laser light pulses from the first optical path to a coaxial optical path through a single lens system using a beam splitter, and receiving reflections of the laser light pulses from the coaxial optical path at the beam splitter. The method may further include directing the reflections of the laser light pulses from the coaxial optical path to a second optical path using the beam splitter, receiving the reflections of the laser light pulses on the second optical path by a receiver module including a plurality of sensor elements, and detecting, by at least one of the plurality of sensor elements, a light blockage in the single lens system.

Additional aspects of the subject disclosure may include reflecting, by a mirror, a portion of the laser light pulses emitted by the transmitter module back toward the receiver module. The method may further include measuring, by a processing system including a processor, degradation of the plurality of emitter elements over time based on the portion of the laser light pulses reflected by the mirror and detected by the receiver module.

In some embodiments, the method may also include adjusting, by the processing system, a power output of the plurality of emitter elements in response to the measured degradation to maintain consistent performance. Additionally, the method may include receiving, by a test receiver module, a portion of the laser light pulses emitted by the transmitter module. In some embodiments, the test receiver module may comprise a complementary metal oxide semiconductor (CMOS) detector.

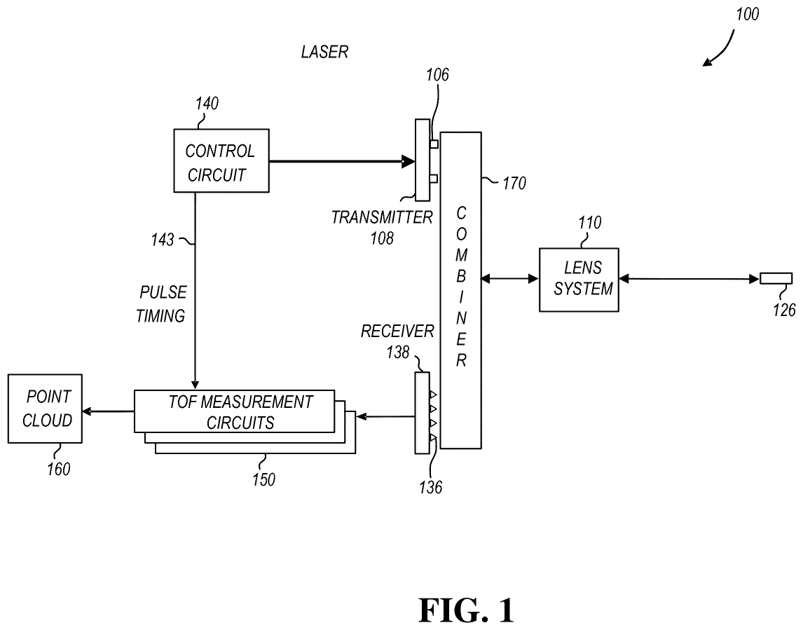

FIG. 1 shows the structure of a LIDAR measuring system 100 in schematic form. Measuring system 100 may be used in any LIDAR application. For example, in some embodiments, measuring system 100 is intended for use on a motor vehicle. As further described below, measuring system 100 may be arranged statically on a motor vehicle and, in addition, is conveniently designed statically itself. This means that the measuring system 100, as well as its components and modules, do not perform any relative movement with respect to each other.

System 100 includes control circuit 140, transmitter module 108, receiver module 138, a single lens system 110, time-of-flight (TOF) measurement circuits 150, point cloud storage device 160, and combiner 170.

The transmitter module 108 includes a multiplicity of emitter elements 106, which for clarity of presentation are shown schematically as squares. The receiver module 138 includes a multiplicity of sensor elements 136. The sensor elements 136 are shown schematically by triangles. Although the emitter elements 106 and sensor elements 136 are shown as squares and triangles, the actual shape of emitter elements 106 and sensor elements 136 can differ from the schematic representation. For example, the emitter elements 106 may be formed by vertical cavity surface-emitting lasers (VCSELs). Also for example, the sensor elements 136 may be formed by single photon avalanche diodes (SPADs). VCSELs and SPADs are provided as examples. Any suitable laser light pulse emitters and sensors may be utilized.

In some embodiments, the transmitter module 108 and the receiver module 138 are designed in a focal plane array (FPA) configuration, where the module and its associated elements are arranged on a particular flat plane. For example, the emitter elements 106 may be arranged on a plane of the transmitter module 108 that is located within the measuring system 100 at the focal plane of the single lens system 110. Similarly, the sensor elements 136 may be arranged on a plane of the receiver module 138 that is located within the measuring system 100 at the focal plane of the single lens system 110.

Combiner 170 is positioned between the transmitter module 108, receiver module 138, and the single lens system 110. The combiner 170 integrates the light paths to and from both the transmitter and the receiver, allowing them to share a common optical path through the lens system 110. In some embodiments, combiner 170 may be implemented using beam splitters, dichroic mirrors, or other optical devices that combine and separate light paths efficiently. For example, a beam splitter may be used to direct emitted laser pulses from transmitter 108 into the lens system 110 while simultaneously directing reflected pulses from the lens system 110 to the receiver 138.

A laser light pulse emitted by an emitter element 106 or a laser light pulse incident on a sensor element 136 passes through the combiner 170 and single lens system 110. The single lens system 110 assigns a specific solid angle to each emitter element 106 and each sensor element 136. As FIG. 1 shows a schematic representation, the solid angle in FIG. 1 is not shown correctly. In particular, the distance from the measuring system to the object is many times greater than the dimensions of the measuring system itself.

Transmitter module 108 is oriented relative to the combiner 170 and single lens system 110 such that a laser light pulse emitted by a particular emitter element 106 is always radiated by the single lens system 110 into the same solid angle. Due to the orientation of the receiver module 138 relative to the combiner 170 and single lens system 110, the sensor elements 136 also always observe the same solid angle. Accordingly, a sensor element 136 is always assigned to the same emitter element 106. In particular, a sensor element 136 and an emitter element 106 may observe the same solid angle. In some embodiments, there is a one-to-one correspondence between emitter elements and sensor elements. Also in some embodiments, there is a one-to-many correspondence between emitter elements and sensor elements. For example, as shown in FIG. 1, a multiplicity of sensor elements 136 may be assigned to a single emitter element 106. The sensor elements 136 which are assigned to a common emitter element 106 are referred to as being part of a macro cell, where the macro cell is assigned to the common emitter element.

An emitter element 106 emits laser light in the form of a laser light pulse at 112 at the beginning of a measurement cycle. This laser light pulse propagates through the combiner 170 and single lens system 110 and is emitted into the solid angle assigned to the emitter element 106. If an object 126 is located within this solid angle, at least part of the laser light pulse is reflected from it. The reflected laser light pulse coming from the corresponding solid angle is propagated through the combiner 170 and single lens system 110 onto the associated sensor element 136 or the sensor elements 136 belonging to a macro cell. The sensor element(s) 136 detect the incident laser light pulse, wherein an indication of the triggering of the sensor elements 136 is provided to one or more of time-of-flight (TOF) measurement circuits 150, and a corresponding distance measurement is written into the point cloud storage device 160. Using the time-of-flight method, the distance from the object 126 to the measuring system 100 can be determined from the round trip transit time of the laser light pulse.

The sequence of such a measurement cycle is controlled by the control circuit 140. In some embodiments, the control circuit 140 is connected or can be connected to other electronic components of a motor vehicle. For example, control circuit 140 may exchange data over a CAN bus within a motor vehicle. The control circuit 140 is shown in FIG. 1 as a single schematic building block. In some embodiments, control circuit 140 may be distributed over a multiplicity of components or assemblies of the measuring system 100. For example, in some embodiments, all or part of the control circuit 140 may be implemented on the receiver module 138.

Control circuit 140 determines laser drive properties and drives transmitter module 108 with signal(s) that cause the emitter element(s) 106 to emit laser light pulses having the specified properties. For example, control circuit 140 may determine values for laser drive power, pulse rate, pulse width, and number of multishot pulses.

In some embodiments, control circuit 140 is implemented using functional circuits such as phase lock loops (PLLs), filters, adders, multipliers, registers, processors, memory, and the like. Accordingly, control circuit 140 may be implemented in hardware, software, or in any combination. For example, in some embodiments, control circuit 140 may include a processor and memory configured to perform the actions described herein, such as controlling the timing of laser light pulses, adjusting emitter power output, and processing data received from the receiver module. The memory may include a non-transitory machine-readable medium that stores executable instructions, which, when read and executed by the processor, facilitate operations such as enabling sensor elements during specific time periods, analyzing backscatter signals to detect obstructions, and measuring degradation of emitter elements over time.

In some embodiments, control circuit 140 may be implemented in an application-specific integrated circuit (ASIC) designed to optimize performance for LIDAR operations. For example, the ASIC may handle faster data path control, such as synchronizing laser pulse timing with sensor activation, while overall control is software programmable to allow flexibility in adapting to different operational requirements. Alternatively, control circuit 140 may be implemented using a general-purpose microcontroller or digital signal processor (DSP) that performs operations such as generating diagnostic reports, adjusting emitter power based on degradation measurements, and integrating ambient light data to detect lens obstructions.

Further, in some embodiments, control circuit 140 may include distributed components, where certain functions are performed by dedicated hardware circuits, such as timing control and signal amplification, while other functions, such as data analysis and system diagnostics, are performed by software running on a processor. The memory may store instructions for operations such as emitting laser pulses, detecting reflections, measuring emitter degradation, and identifying obstructions in the lens system.

Time-of-flight (TOF) measurement circuits 150 are each coupled to one or more of the sensor elements 136 or one or more of the macro cells to which the sensor elements 136 may be assigned. TOF measurement circuits 150 receive laser light pulse timing information 143 from control circuit 140 and compare it to the timing of received laser light pulses to measure round trip times-of-flight of light pulses, thereby measuring the distance (Z) to the point in the field of view from which the laser light pulse was reflected. Accordingly, TOF measurement circuits 150 measure the distance between LIDAR measurement system 100 and measurement points in the field of view at which laser light pulses are reflected.

TOF measurement circuits 150 may be implemented with any suitable circuit elements. For example, in some embodiments, TOF measurement circuits 150 include digital and/or analog timers, integrators, correlators, comparators, registers, adders, or the like to compare the timing of the reflected laser light pulses with the pulse timing information received from control circuit 140.

Point cloud storage 160 receives TOF information corresponding to distance (Z) information from TOF measurement circuits 150. In some embodiments, the TOF measurements are held in point cloud storage 160 in an array format such that the location within point cloud storage 160 indicates the location within the field of view from which the measurement was taken. In other embodiments, the TOF measurements held in point cloud storage 160 include (X, Y) position information as well as TOF measurement information to yield (X, Y, Z) as a three-dimensional (3D) data set that represents a depth map of the measured portion of the field of view 128. The point cloud data may then be used for any suitable purpose. Examples include 3D imaging, velocity field estimation, object recognition, and the like.

Point cloud storage 160 may be implemented using any suitable circuit structure. For example, in some embodiments, point cloud storage 160 is implemented in a dual port memory device that can be written on one port and read on a second port. In other embodiments, point cloud storage 160 is implemented as data structures in a general purpose memory device. In still further embodiments, point cloud storage 160 is implemented in an application specific integrated circuit (ASIC).

In some embodiments, single lens system 110 is designed to provide a wide field of view in at least one dimension. For example, in some embodiments, LIDAR measurement system 100 has a horizontal field of view (HFOV) of at least 120 degrees, at least 160 degrees, or at least 180 degrees. Various embodiments maintain spatial relationships between the lens system and a housing (not shown in FIG. 1) that provide the ability for a wide HFOV (e.g., equal to or greater than 180 degrees).

In some embodiments, transmitter module 108 is oriented relative to combiner 170 and single lens system 110 to provide a symmetric vertical field of view. In other embodiments, transmitter module 108 is oriented relative to combiner 170 and single lens system 110 to provide an asymmetric vertical field of view. Similarly, in some embodiments, receiver module 138 is oriented relative to combiner 170 and single lens system 110 to provide a symmetric vertical field of view, and in other embodiments, receiver module 138 is oriented relative to combiner 170 and single lens system 110 to provide an asymmetric vertical field of view. These and other embodiments are further described below.

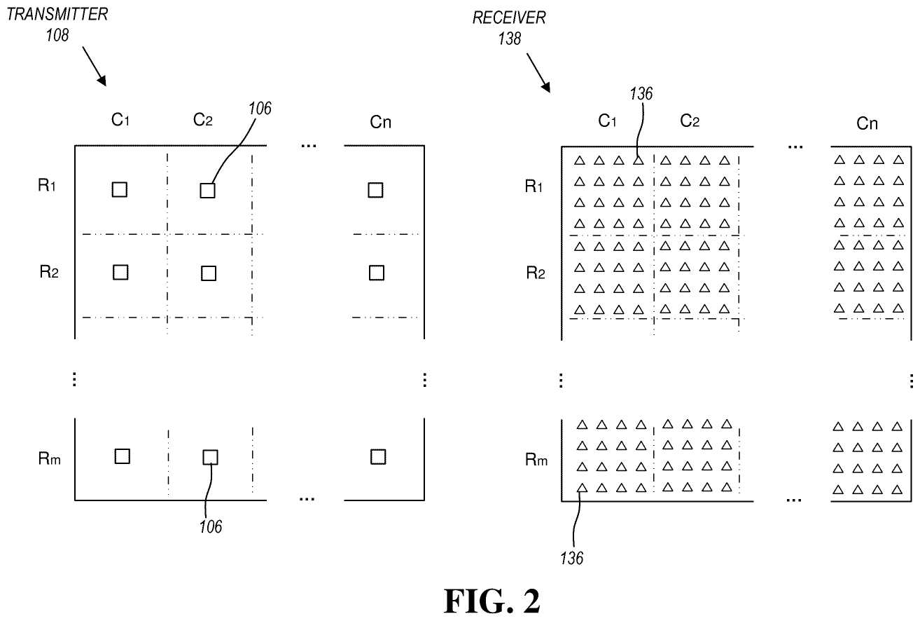

FIG. 2 shows a transmitter module 108 and the receiver module 138 schematically in a front view in accordance with various aspects described herein. Only a partial detail is shown, the additional areas being represented by ellipses in the figure. The transmitter module 108 comprises the emitter elements 106 already described. In some embodiments, the emitter elements are arranged in rows and columns. The columns are designated as [C1-Cn], and the rows are designated as [R1-Rm], where n and m represent the number of columns and rows, respectively. The various embodiments may include any number of row and columns (e.g., n and m may take any value).

The receiver module 138 comprises a plurality of sensor elements 136. In some embodiments, the number of sensor elements 136 is equal to the number of emitter elements 106. In other embodiments, as shown in FIG. 2, the number of sensor elements 136 is greater than the number of emitter elements 106. The sensor elements 136 are also implemented in a row and column arrangement. This row and column arrangement is also selected purely as an example. The rows and columns of the receiver module 138 are numbered similar to the rows and columns of the transmitter module 108. In some embodiments, a row and column of receiver module 138 corresponds to the location of a single sensor element 136. In other embodiments, as shown in FIG. 2, a row and column of receiver module 138 corresponds to a location that includes multiple sensor elements 136 (e.g., a macro cell). In the example of FIG. 2, the macro cells are separated from each other by dashed lines for better presentation. In some embodiments, the sensor elements 136 of a macro cell are all assigned to a single emitter element 106. For example, the macro cell located at R1,C2 of receiver module 138 is assigned to the emitter element 106 located at R1,C2 of transmitter module 108. A reflected laser light pulse that was emitted by the sensor element 106 located at R1,C2 of transmitter module 108 images at least a part of the sensor elements 136 of the associated macro cell located at R1,C2 of receiver module 138.

The sensor elements 136 can advantageously be activated and deactivated individually or in groups. As a result, the relevant sensor elements 136 of a macro cell can be activated and the irrelevant ones can be deactivated. This enables the compensation of imaging errors such as, for example, static errors, (e.g., imaging errors of the lens systems 110, 130) or parallax errors (e.g., errors resulting from near objects vs. far objects).

In some embodiments, the emitter elements 106 of the measuring system 100 emit their light pulses sequentially, for example emitter by emitter, column by column, or row by row. This prevents a row or column of emitter elements 106 from triggering the sensor elements 136 of the adjacent row or column of macro cells. In some embodiments, the only sensor elements 136 of the macro cells that are active are those for which the corresponding emitter elements 106 have emitted a laser light pulse. Additionally, in some embodiments, each emitter element 106 may have its laser power adjusted individually. For example, the laser power of an emitter element 106 may be increased to improve detection of distant objects or reduced to avoid oversaturation of the receiver module 138 when measuring close objects. This individual power control allows for more precise energy management, enabling the system to optimize power consumption and maintain compliance with eye safety regulations. Furthermore, individual power adjustment can compensate for variations in emitter performance due to aging or manufacturing tolerances, ensuring consistent measurement accuracy across the entire array of emitter elements 106.

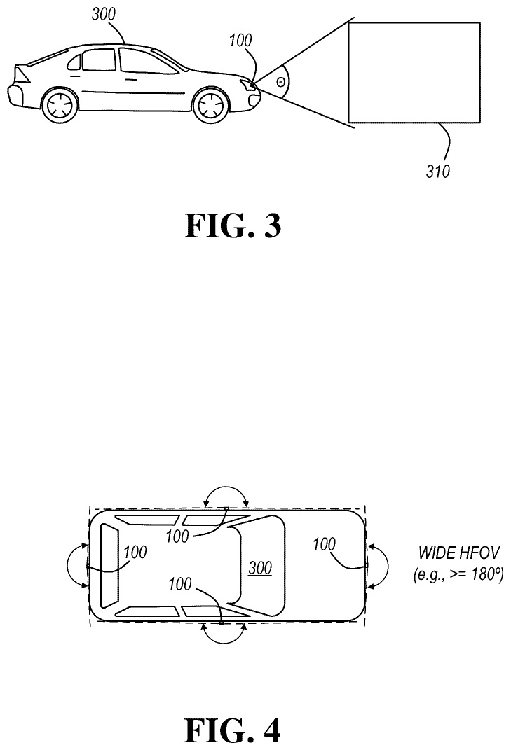

FIG. 3 shows an automotive application of a LIDAR measurement system in accordance with various aspects described herein. As shown in the side view of a vehicle 300 in FIG. 3, vehicle 300 includes LIDAR measurement system 100 at the front of the vehicle. LIDAR measurement system 100 illuminates points within field of view (FOV) 310 with laser light pulses to measure distances as described above. The vertical FOV (VFOV) is shown as angle Θ, which can take on any value, including greater than 180 degrees. Although much of the remainder of this description describes the LIDAR system in the context of an automotive application, the various embodiments described herein are not limited in this respect.

In some embodiments, the vertical field of view Θ may be symmetric about a horizontal axis, and in other embodiments, the vertical field of view Θ may be asymmetric about a horizontal axis. In some embodiments, LIDAR measurement system 100 is positioned just inside a vehicle body panel. For example system 100 may be positioned adjacent to an inside surface of a body panel on the front of vehicle 300 (e.g., a bumper cover). Further, in some embodiments, the lens systems (e.g., single lens system 110) may protrude through the vehicle body panel to provide a wide field of view.

FIG. 4 shows an automotive application of a LIDAR measurement system in accordance with various aspects described herein. As shown in a top view of vehicle 300 in FIG. 4, vehicle 300 includes a first LIDAR measurement system 100 at the front of the vehicle. In some embodiments, the LIDAR measurement system 100 at the front of the vehicle illuminates points within a wide horizontal field of view (HFOV) and/or a wide vertical field of view (VFOV). For example, in some embodiments, LIDAR measurement system 100 has a HFOV of at least 120 degrees, at least 160 degrees, or at least 180 degrees. Also for example, in some embodiments, LIDAR measurement system 100 has a VFOV of at least 120 degrees, at least 160 degrees, or at least 180 degrees. In some embodiments, vehicle 300 includes more than one LIDAR measurement system. For example, vehicle 300 may have one or more LIDAR measurement system 100 on sides and rear of the vehicle. In some embodiments, the LIDAR measurement systems 100 at the sides and rear of the vehicle illuminates points within a wide horizontal field of view (HFOV) (e. g, greater than 180 degrees), resulting in a 360 degree view about the vehicle. Also in some embodiments, the LIDAR measurement systems 100 at the sides and rear of the vehicle are positioned adjacent to an inside surface of a vehicle body panel with the single lens system protruding through the vehicle body panel to allow for a wide HFOV. Although much of the remainder of this description describes the LIDAR system in the context of an automotive application, the various embodiments described herein are not limited in this respect.

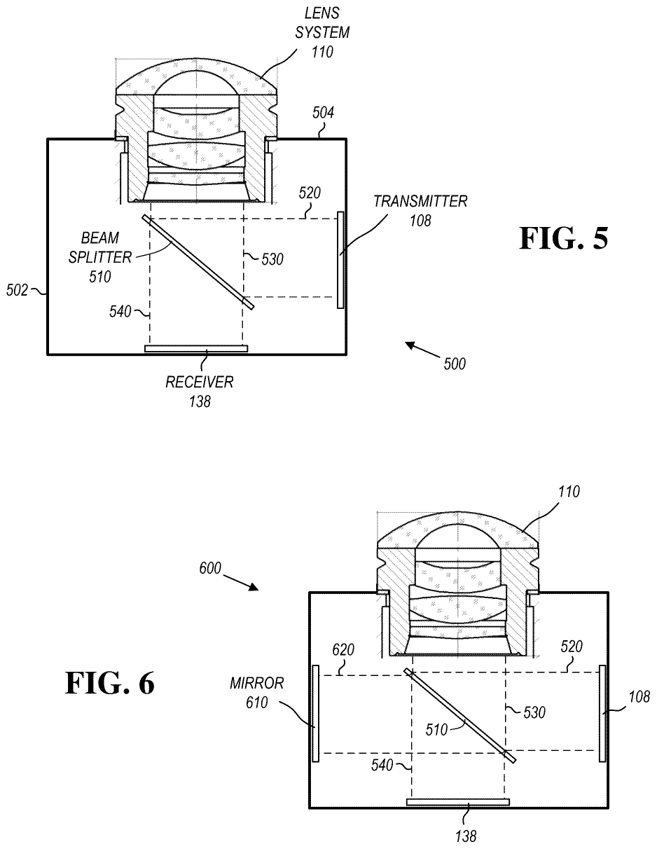

FIG. 5 shows a cross section view of a LIDAR measurement system in accordance with various aspects described herein. The cross-sectional view of lidar measurement system 100 shows housing 502 with bezel 504. Lens system 110 is shown protruding through bezel 504, with at least a portion of the lens systems being positioned outside of housing 502. In some embodiments, when installed in a motor vehicle, bezel 504 may be positioned on the inside surface of a body panel (e.g., a bumper cover), and the lens system 110 protrude far enough outside of bezel 504 such that it also protrudes outside of the body panel.

The lens system 110 is a single lens system shared by both the transmitter module 108 and the receiver module 138, enabling a coaxial optical path 530 that eliminates parallax effects and reduces the overall size of the system. The transmitter module 108 is positioned to emit laser light pulses on a first optical path 520. These pulses are directed to a beam splitter 510, which reflects the laser light pulses from first optical path 520 to coaxial optical path 530. Accordingly, beam splitter 510 directs the laser light pulses from the transmitter module to the lens system (110) and subsequently to a field of view in the external environment.

Reflected laser light pulses from objects in the environment are captured by the lens system 110 and directed back to the beam splitter 510 on coaxial optical path 530, and then onto the receiver module 138 on second optical path 540. The receiver module detects the reflections and processes the data to determine distances using time-of-flight measurements.

Beam splitter 510 represents an embodiment of combiner 170 shown in FIG. 1, serving to integrate the optical paths of the transmitter module 108 and the receiver module 138 into a shared coaxial optical path through the lens system 110. By directing laser light pulses emitted by the transmitter module 108 from the first optical path to the coaxial optical path and simultaneously directing reflections of the laser light pulses from the coaxial optical path to the second optical path, beam splitter 510 enables the compact and efficient design of the LIDAR system. In some embodiments, beam splitter 510 may be implemented using a partially reflective mirror, which reflects a portion of the laser light while allowing the remainder to pass through. Alternatively, beam splitter 510 may be implemented using dichroic coatings, which selectively reflect or transmit light based on wavelength, enabling precise control over the optical paths. In other embodiments, beam splitter 510 may be realized using a polarization-based splitter, which separates light based on its polarization state. These implementations allow for flexibility in designing the optical system to optimize performance, minimize energy loss, and ensure compatibility with the specific requirements of the LIDAR system.

The system depicted in FIG. 5 is capable of detecting blockages or obstructions in the lens system 110 by utilizing the coaxial optical path 530 and the shared use of the lens system 110 for both the transmitter module 108 and the receiver module 138. This configuration enables the system to monitor the integrity of the lens system by analyzing the behavior of both emitted and reflected laser light pulses.

In some embodiments, the system detects blockages by analyzing backscatter from the lens system 110. For example, when the transmitter module 108 emits laser light pulses, a portion of the light may be reflected back toward the receiver module 138 by the surface of the lens system itself. If the lens system is clean and unobstructed, the backscatter signal may exhibit a predictable intensity and distribution. However, if there is a blockage, such as dirt, dust, or other contaminants on the lens, the backscatter signal may deviate from the expected pattern. For example, the obstruction may cause an increase in detected energy on one or more sensors due to additional scattering or reflection from the contaminant. The receiver module 138 may detect these deviations, and the processing system may analyze the data to determine the presence and location of the blockage.

In other embodiments, the system may detect blockages by integrating ambient light received through the lens system 110 over time. For example, the receiver module 138 may continuously monitor the ambient light levels at each of its sensor elements. If a portion of the lens system is obstructed, the corresponding sensor elements may detect a lower return of ambient light compared to unobstructed areas. By comparing the light levels across the sensor array, the system may identify regions of the lens system that are blocked or contaminated.

The coaxial optical path design further enhances the system's ability to detect blockages. Since both the emitted and reflected light pulses pass through the same lens system 110, any obstruction may affect both the transmission and reception of light. For example, if the system detects a consistent reduction in both the emitted and received light intensity, it may infer that the lens system is partially or fully obstructed. This dual impact simplifies the identification and diagnosis of blockages.

FIG. 6 illustrates a cross-sectional view of a LIDAR measurement system 600, which is similar to the system shown in FIG. 5 but includes the addition of a mirror 610. The mirror 610 is positioned within the system to reflect a portion of the laser light pulses emitted by the transmitter module 108 back toward the receiver module 138. This configuration enables additional functionality, such as monitoring the performance of the transmitter module 108 and detecting degradation of the emitter elements over time.

The transmitter module 108 emits laser light pulses along a first optical path 520. These pulses are directed to the beam splitter 510, which reflects the laser light pulses onto a coaxial optical path 530 through the lens system 110. The lens system 110 focuses the laser light pulses and projects them toward the external environment. Reflected laser light pulses from objects in the environment are captured by the lens system 110 and directed back along the coaxial optical path 530 to the beam splitter 510. The beam splitter 510 then directs the reflected pulses onto a second optical path 540, where they are received by the receiver module 138.

In addition to facilitating the primary measurement operations, the mirror 610 is positioned along a third optical path 620 to reflect a portion of the laser light pulses emitted by the transmitter module 108 back toward the receiver module 138. This internal reflection allows the system to perform diagnostic operations. For example, the receiver module 138 can detect the portion of the laser light pulses reflected by the mirror 610, and the processing system can analyze this data to measure degradation of the emitter elements in the transmitter module 108 over time. Various embodiments may utilize this functionality to maintain consistent performance by identifying and compensating for aging or malfunctioning emitter elements. The inclusion of the mirror 610 also supports operations such as adjusting the power output of individual emitter elements in response to measured degradation. For example, if the processing system detects reduced output from a specific emitter element, it may increase the power output of that element to maintain consistent performance.

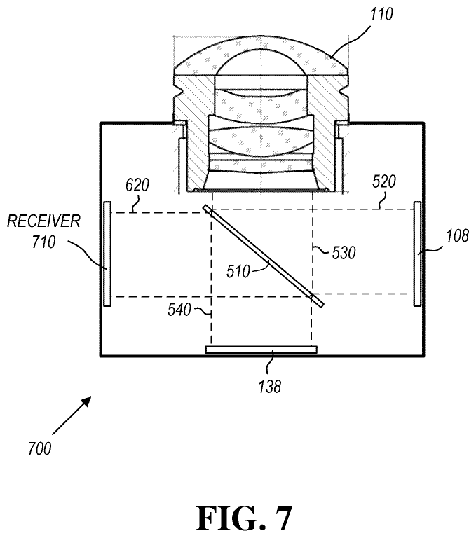

FIG. 7 shows a cross section view of a LIDAR measurement system in accordance with various aspects described herein. FIG. 7 illustrates a cross-sectional view of a LIDAR measurement system 700, which is similar to the system shown in FIG. 6 but replaces the mirror 610 with a test receiver module 710. The test receiver module 710 is positioned within the system to receive a portion of the laser light pulses emitted by the transmitter module 108. This configuration enables diagnostic operations to monitor the performance of the transmitter module 108 and detect degradation of the emitter elements over time.

The transmitter module 108 emits laser light pulses along a first optical path 520. These pulses are directed to the beam splitter 510, which reflects the laser light pulses onto a coaxial optical path 530 through the lens system 110. The lens system 110 focuses the laser light pulses and projects them toward the external environment. Reflected laser light pulses from objects in the environment are captured by the lens system 110 and directed back along the coaxial optical path 530 to the beam splitter 510. The beam splitter 510 then directs the reflected pulses onto a second optical path 540, where they are received by the receiver module 138.

In addition to facilitating the primary measurement operations, the test receiver module 710 is positioned along a third optical path 620 to receive a portion of the laser light pulses emitted by the transmitter module 108. The test receiver module 710 may be the same part as the receiver module 138 or it may be a different component. For example, the test receiver module 710 may have a different number of sensor elements compared to the receiver module 138, or it may utilize a different technology altogether. In some embodiments, the test receiver module 710 may be implemented as a complementary metal oxide semiconductor (CMOS) detector. A CMOS detector, while less expensive than other sensor technologies, may not measure photons with sufficient accuracy to support time-of-flight calculations. However, it can detect energy with enough precision to determine whether an emitter element in the transmitter module 108 is degraded.

The processing system analyzes the data received by the test receiver module 710 to measure the performance of the emitter elements. For example, if the test receiver module 710 detects a reduction in the energy of the laser light pulses, the processing system may identify degradation in one or more emitter elements. This information can be used to adjust the power output of the degraded emitter elements or to trigger maintenance actions, ensuring consistent performance of the LIDAR measurement system.

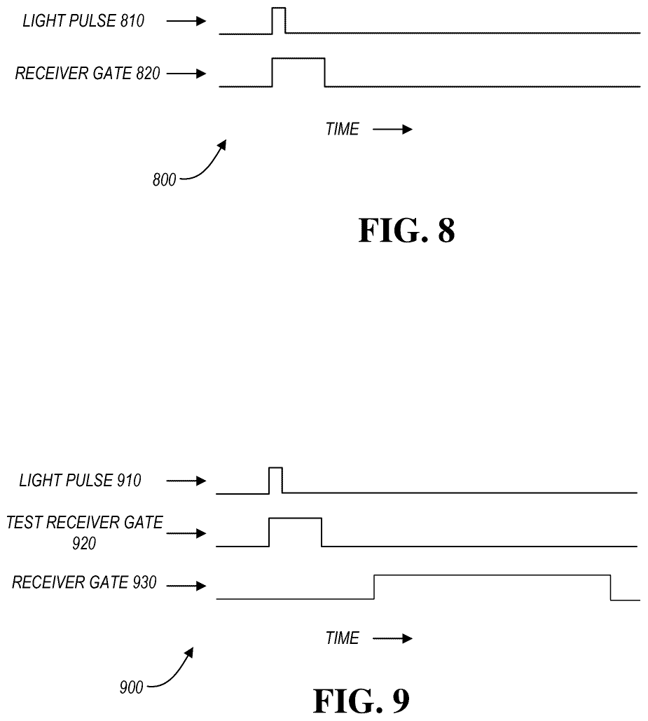

FIG. 8 shows a timing diagram representing operation of a LIDAR measurement system in accordance with various aspects described herein. Timing diagram 800 represents the operation of a LIDAR system (e.g., system 500, FIG. 5) when the receiver module 138 may detect a blockage in the single lens system 110. The timing diagram 800 provides insight into the temporal relationship between the laser light pulses emitted by the transmitter module 108 and the activation of the sensors in the receiver module 138.

Referring back to FIG. 5, a laser pulse emitted by the transmitter module 108 may be directed onto the coaxial optical path 530 by the beam splitter 510. The laser pulse propagates to the single lens system 110 (and beyond) and interacts with the external environment. If a blockage exists in the single lens system 110, a portion of the laser pulse may be reflected back toward the receiver module 138. The beam splitter 510 directs this reflection onto the second optical path 540, where it is detected by the receiver module 138.

The timing diagram 800 includes two elements: the light pulse 810 and the receiver gate 820. The light pulse 810 represents the laser light pulses emitted by the transmitter module 108. In some embodiments, these pulses are emitted at specific intervals to illuminate the field of view and facilitate distance measurements. In other embodiments, these pulses are emitted for the sole purpose of detecting blockages in the single lens system 110. The receiver gate 820 represents the time period during which the sensors in the receiver module 138 are enabled to detect incoming photons. By synchronizing the receiver gate 820 with the emitted light pulses 810, the system activates the sensors during the expected arrival time of reflections.

In some embodiments, one or more sensors in the receiver module 138 may detect photons that are indicative of a blockage in the single lens system 110. For example, the blockage may cause an increase in backscatter or other anomalies in the detected signal. The processing system analyzes the data from the sensors to identify the presence and location of the blockage.

FIG. 9 shows a timing diagram representing operation of a LIDAR measurement system in accordance with various aspects described herein. Timing diagram 900 represents the operation of a LIDAR system when the test receiver module 710 and the receiver module 138 are used in conjunction to detect a blockage in the single lens system 110 and perform time-of-flight calculations. This operation corresponds to the configuration shown in FIG. 7, where the mirror 610 is replaced by the test receiver module 710.

The timing diagram 900 includes three elements: the light pulse 910, the test receiver gate 920, and the receiver gate 930. The light pulse 910 represents the laser light pulses emitted by the transmitter module 108. In some embodiments, these pulses are emitted at specific intervals to illuminate the field of view and facilitate measurements. The test receiver gate 920 represents the time period during which the sensors in the test receiver module 710 are enabled to detect incoming photons. Similarly, the receiver gate 930 represents the time period during which the sensors in the receiver module 138 are enabled to detect incoming photons.

In some embodiments, a single laser pulse 910 can be used for dual purposes. First, the test receiver module 710, enabled by the test receiver gate 920, can detect photons reflected internally within the system to identify blockages or contamination in the single lens system 110. For example, the test receiver module 710 may detect anomalies in the reflected signal, such as increased backscatter or increased energy levels, which are indicative of a reflection caused by a blockage in single lens system 110. Second, the receiver module 138, enabled by the receiver gate 930, can detect photons reflected from external objects to perform time-of-flight calculations. These calculations determine the distance between the LIDAR system and the objects in the field of view.

The use of the test receiver module 710 provides additional diagnostic capabilities, allowing the system to monitor the integrity of the single lens system 110 while simultaneously performing standard LIDAR operations. In some embodiments, the test receiver module 710 may be implemented as a complementary metal oxide semiconductor (CMOS) detector, which, while less expensive, can detect energy levels with sufficient accuracy to identify emitter degradation or lens blockages. The receiver module 138, on the other hand, is configured to perform precise time-of-flight calculations.

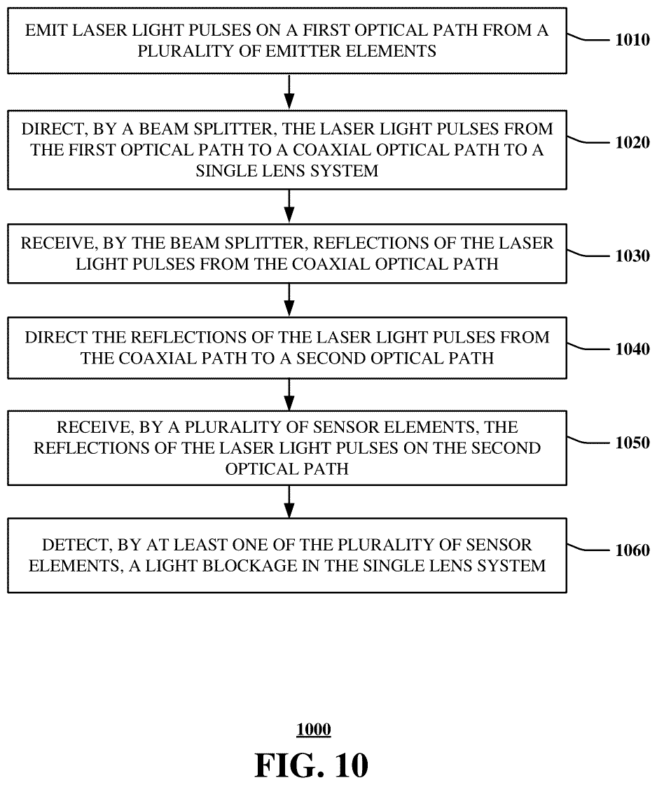

FIG. 10 depicts an illustrative embodiment of a method in accordance with various aspects described herein. In some embodiments, method 1000, or portions thereof, is performed by a LIDAR measurement system. In other embodiments, method 1000 is performed by a larger system such as a vehicle. Method 1000 is not limited by the particular type of apparatus performing the method. The various actions in method 1000 may be performed in the order presented or may be performed in a different order. Further, in some embodiments, some actions listed in FIG. 10 are omitted from method 1000.

Method 1000 is shown beginning with block 1010 in which laser light pulses are emitted on a first optical path from a plurality of emitter elements in a transmitter module. In some embodiments, the characteristics of the laser light pulses (e.g., power, pulse width, timing, etc.) are configured by a control circuit, such as control circuit 140 (FIG. 1). Examples of housings holding one or more emitters are shown in FIGS. 5 and 6 at housing 502. In some embodiments, the laser light pulses may be emitted sequentially, such as emitter by emitter, row by row, or column by column, to prevent interference between adjacent sensor elements in the receiver module. Alternatively, the laser light pulses may be emitted in a pattern optimized for energy efficiency or detection accuracy. The power output of each emitter element may be individually adjusted to compensate for aging, optimize detection of objects at varying distances, or ensure compliance with eye safety regulations

At block 1020, the method involves directing the laser light pulses from the first optical path to a coaxial optical path to a single lens system using a beam splitter. In some embodiments, the beam splitter may be implemented using a partially reflective mirror, dichroic coatings, or polarization-based splitters to optimize the transmission and reflection of light. The single lens system may be configured to provide a wide field of view, such as at least 180 degrees in one or more dimensions, and may protrude through a housing to ensure unobstructed operation. For example, in some embodiments, single lens system is configured to provide a field of view of at least 180 degrees in two dimensions (e.g. horizontally and vertically).

At block 1030, the method involves receiving reflections of the laser light pulses from the coaxial optical path at the beam splitter. In some embodiments, the reflections may include backscatter from the lens system itself, which can be analyzed to detect blockages or contamination. The beam splitter may direct the reflections to multiple optical paths, including a second optical path for time-of-flight calculations and a third optical path for diagnostic operations.

At block 1040, the method involves directing the reflections of the laser light pulses from the coaxial optical path to a second optical path using the beam splitter. In some embodiments, the beam splitter may prioritize the transmission of reflected light to the receiver module by using an asymmetric reflectivity-to-transmissivity ratio. The second optical path may be configured to optimize the detection of reflections from external objects for accurate distance measurements.

At block 1050, the method involves receiving the reflections of the laser light pulses on the second optical path by a plurality of sensor elements in the receiver module. In some embodiments, the receiver module may include sensor elements arranged in rows and columns, with subsets of sensors selectively activated to reduce power consumption or compensate for imaging errors. The receiver module may also detect variations in the reflected light caused by environmental factors, such as temperature or humidity, and adjust its operation accordingly.

At block 1060, the method involves detecting, by at least one of the plurality of sensor elements, a light blockage in the single lens system. In some embodiments, the blockage may be detected by analyzing backscatter from the lens system or by integrating ambient light received through the lens system over time. For example, a lower return of ambient light on certain sensor elements may indicate the presence of dirt, dust, or other contaminants on the lens. The processing system may analyze the data to determine the presence, location, and severity of the blockage.

While for purposes of simplicity of explanation, the respective processes are shown and described as a series of blocks in FIG. 10, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a transmitter module including a plurality of emitter elements to emit laser light pulses on a first optical path;
a receiver module including a plurality of sensor elements to detect reflections of the laser light pulses on a second optical path;
a single lens system positioned along a coaxial optical path;
a beam splitter positioned to direct the laser light pulses from the first optical path to the coaxial optical path and to direct the reflections of the laser light pulses from the coaxial optical path to the second optical path;
a processing system including a processor; and
a memory that stores executable instructions that, when executed by the processing system, facilitate performance of operations, the operations comprising:
emitting a first set of laser light pulses from the plurality of emitter elements;
receiving a first set of reflections of the first set of laser light pulses at less than all of the plurality of sensor elements; and
determining that the first set of reflections were reflected by the single lens system.

2. The system of claim 1, further comprising a mirror positioned to reflect a portion of the laser light pulses onto the second optical path to enable the receiver module to test the transmitter module.

3. The system of claim 1, further comprising a test receiver module positioned to receive a portion of the laser light pulses to test the transmitter module.

4. The system of claim 3, wherein the test receiver module comprises a second plurality of sensor elements, and wherein a number of the plurality of sensor elements of the receiver module is equal to a number of the second plurality of sensor elements of the test receiver module.

5. The system of claim 3, wherein the test receiver module comprises a complementary metal oxide semiconductor (CMOS) detector.

6. The system of claim 1, the operations further comprising:
enabling the plurality of sensor elements during a time period that allows reflections to be received from the single lens system and that does not allow reflections to be received from objects in a field of view beyond the single lens system.

7. The system of claim 1, wherein the single lens system is positioned to protrude through a housing of the system to provide a field of view of at least 180 degrees in at least one dimension.

8. The system of claim 1, the operations further comprising:
integrating, at each of the plurality of sensor elements, ambient light received through the single lens system over time;
detecting a lower return on at least one of the plurality of sensor elements; and
determining, based on the lower return, that the single lens system has an obstruction.

9. A light detection and ranging (LIDAR) measurement system, comprising:
a transmitter module including a plurality of emitter elements to emit laser light pulses on a first optical path;
a receiver module including a plurality of sensor elements to detect reflections of the laser light pulses on a second optical path;
a single lens system positioned along a coaxial optical path;
a beam splitter positioned to direct the laser light pulses from the first optical path to the coaxial optical path and to direct the reflections of the laser light pulses from the coaxial optical path to the second optical path;
a mirror positioned to reflect a portion of the laser light pulses emitted by the transmitter module back toward the receiver module;
a processing system including a processor; and
a memory that stores executable instructions that, when executed by the processing system, facilitate performance of operations, the operations comprising:
measuring degradation of the plurality of emitter elements over time based on the portion of the laser light pulses reflected by the mirror and detected by the receiver module.

10. The LIDAR measurement system of claim 9, the operations further comprising:
modifying a power output of the plurality of emitter elements in response to the degradation of the emitter elements over time.

11. The LIDAR measurement system of claim 10, wherein the modifying the power output of the plurality of emitter elements comprises individually modifying the power output of the plurality of emitter elements.

12. The LIDAR measurement system of claim 11, the operations further comprising:
emitting a first set of laser light pulses from the plurality of emitter elements;
receiving a first set of reflections of the first set of laser light pulses at less than all of the plurality of sensor elements; and
determining that the first set of reflections were reflected by the single lens system.

13. The LIDAR measurement system of claim 9, wherein the single lens system is positioned to protrude through a housing of the system to provide a field of view of at least 180 degrees in at least one dimension.

14. The LIDAR measurement system of claim 9, the operations further comprising:
integrating, at each of the plurality of sensor elements, ambient light received through the single lens system over time;
detecting a lower return on at least one of the plurality of sensor elements; and
determining, based on the lower return, that the single lens system has an obstruction.

15. A method, comprising:
emitting, by a transmitter module including a plurality of emitter elements, laser light pulses on a first optical path;
directing, by a beam splitter, the laser light pulses from the first optical path to a coaxial optical path through a single lens system;
receiving, by the beam splitter, reflections of the laser light pulses from the coaxial optical path;
directing, by the beam splitter, the reflections of the laser light pulses from the coaxial optical path to a second optical path;
receiving, by a receiver module including a plurality of sensor elements, the reflections of the laser light pulses on the second optical path; and
detecting, by at least one of the plurality of sensor elements, a light blockage in the single lens system.

16. The method of claim 15, further comprising reflecting, by a mirror, a portion of the laser light pulses emitted by the transmitter module back toward the receiver module.

17. The method of claim 16, further comprising measuring, by a processing system including a processor, degradation of the plurality of emitter elements over time based on the portion of the laser light pulses reflected by the mirror and detected by the receiver module.

18. The method of claim 17, further comprising adjusting, by the processing system, a power output of the plurality of emitter elements in response to the degradation to maintain consistent performance.

19. The method of claim 15, further comprising receiving, by a test receiver module, a portion of the laser light pulses emitted by the transmitter module.

20. The method of claim 19, wherein the test receiver module comprises a complementary metal oxide semiconductor (CMOS) detector.
